(19) United States
(12) Patent Application Publication
(10) Pub. No.: US 2008/0040177 A1
(43) Pub. Date: Feb. 14, 2008

(54) Method and apparatus for automatic out of office assistant activation

(75) Inventors: John Vuong, San Jose, CA (US); Sarah Korah, San Jose, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/479,468

(22) Filed: Jun. 30, 2006

(51) Int. Cl. G05B 19/418

(52) U.S. Cl. 705/8

(57) ABSTRACT

A telecommunications system includes a calendar system; and an out of office assistant configured to activate responsive to one or more entries maintained in the calendar system. According to some embodiments, the out of office assistant is configured to activate based on user-configurable fields applied to calendar appointments maintained by the calendar system. According to some embodiments, the out of office assistant is configured to activate based on calendar appointments maintained by the calendar system. According to some embodiments, a reply message is generated based on content of a calendar maintained by the calendar system

### BACKGROUND OF THE INVENTION

1. Field of the Invention

The present invention relates to telecommunications systems and, in particular, to an improved electronic mail system.

2. Description of the Related Art

Modern-electronic mail systems employ an “out of office assistant” for answering e-mail or other messaging when the user is not available to answer a message, such as when the user is on vacation or on a business trip. Typically, when a user knows he is going to be unavailable, he activates his “out of office” assistant, which causes it to generate a preconfigured message to other parties who write to the user during the period of unavailability. However, users often forget to activate or deactivate the out of office assistant when they go on vacation and deactivate it when they return.

### SUMMARY OF THE INVENTION

These and other drawbacks in the prior art are overcome in large part by a system and method according to embodiments of the present invention.

A method according to embodiments of the present invention includes creating a calendar appointment in a calendar program; and automatically activating an out of office assistant at a time of said appointment. According to some embodiments, the automatically activating includes generating a message responsive to an incoming message during a time of said appointment. A method according to embodiments of the present invention further includes applying one or more descriptive entry fields to said appointment, wherein said automatically activating includes generating a message responsive to said one or more descriptive entry fields.

A telecommunications system according to another embodiment of the present invention includes a calendar system; and an out of office assistant configured to activate responsive to one or more entries maintained in the calendar system. According to some embodiments, the out of office assistant is configured to activate based on user-configurable fields applied to calendar appointments maintained by the calendar system. According to some embodiments, the out of office assistant is configured to activate based on calendar appointments maintained by the calendar system. According to some embodiments, a reply message is generated based on content of a calendar appointment maintained by the calendar system.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram illustrating a system according to embodiments of the present invention.

FIG. 2 is a diagram illustrating a system according to embodiments of the present invention.

FIG. 3 is a flowchart illustrating operation of embodiments of the present invention.

FIG. 4 is a diagram of an exemplary user interface according to embodiments of the present invention.

FIG. 5 illustrates exemplary user messages according to an embodiment of the present invention.

FIG. 6 is a diagram schematically illustrating operation of embodiments of the present invention.

FIG. 7 is a flowchart illustrating operation of embodiments of the present invention.

FIG. 8 is a diagram illustrating signaling according to an embodiment of the present invention.

FIG. 9 is a diagram illustrating signaling according to an embodiment of the present invention.

FIG. 10 is a diagram illustrating signaling according to an embodiment of the present invention.

FIG. 11 is a block diagram of a user device according to embodiments of the present invention.

### DETAILED DESCRIPTION OF EMBODIMENTS OF THE INVENTION

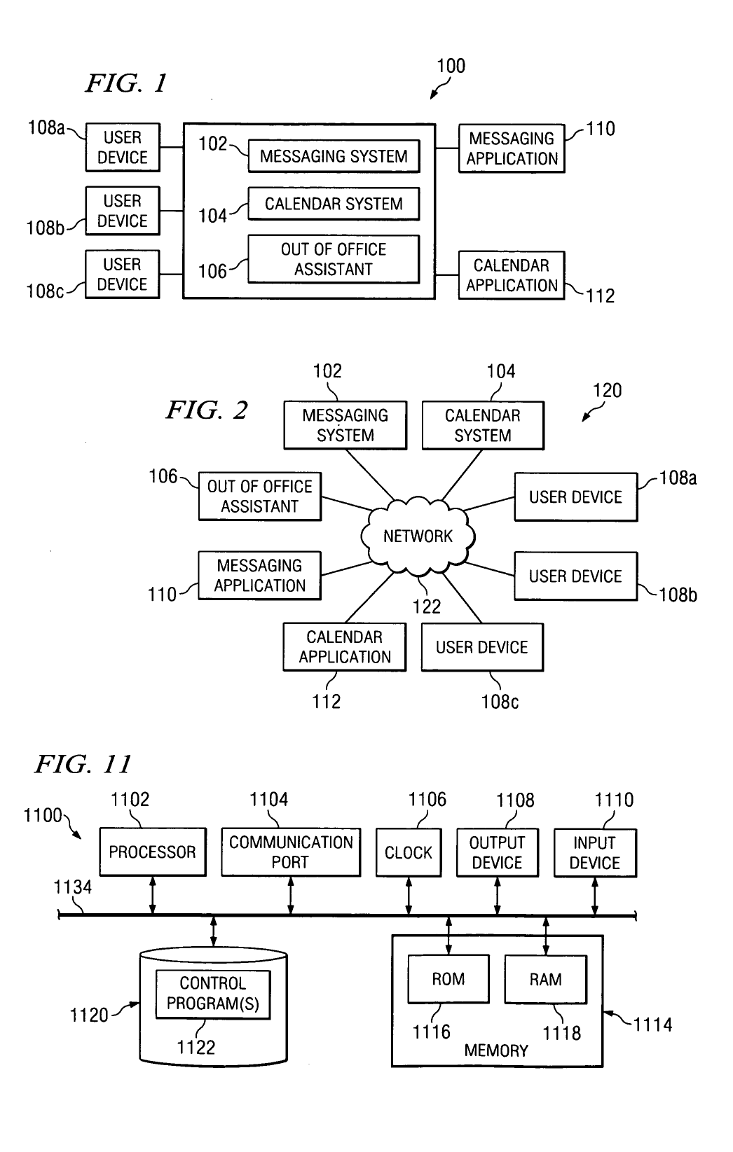

Turning now to the drawings and, with particular attention to FIG. 1, a diagram of a telecommunications system 100 in accordance with embodiments of the present invention is shown. In the embodiment illustrated, the system 100 includes a messaging system 102, calendar system 104, out of office assistant 106, one or more user devices 108a-108c, a messaging application 110 and a calendar application 112.

The messaging system 102 may be embodied, for example, as an electronic mail, or e-mail messaging system. The messaging system 102 thus interacts with the messaging application 110, to provide messaging services to users. Similarly, the calendar system 104 may operate to provide a central calendar server to one or more calendar applications 112. The messaging and calendar systems and applications may be implemented in hardware and/or software operating on one or more servers, computer systems, host or mainframe computers, workstations, etc. An exemplary system that may be suitably modified in accordance with the teachings of the present invention and used to implement the calendar and messaging system is the Openscape system, available from Siemens Corporation.

The Out of Office Assistant 106 may couple to or be in communication with the messaging and calendar system and/or applications and allows users to set out of office activation parameters, as will be explained in greater detail below. The Out of Office Assistant 106 further allows for generation of one or more out of office messages. The Out of Office Assistant 106 may be implemented in hardware and/or software operating on one or more servers, computer systems, host or mainframe computers, workstations, etc.

User devices, such as user devices 108a-108c may be connected to or in communication with the e-mail system 102 and calendar system 104. In certain embodiments, the user devices may be implemented as telephones, cellular telephones, PDAs, computers, etc. For example, a user device 108a-108c may be embodied as personal computers implementing the Windows XP operating system. In such embodiments, the messaging application 110 and calendar application 112 may include programs running on the user devices 108a-108c.

In certain embodiments, the system 100 may also include other hardware and/or software components (e.g., gateways, proxy servers, registration server, presence servers, redirect servers, databases, applications, etc.) such as, for example, hardware and software used to support a SIP (Session Initiation Protocol) or other protocol based infrastructure for the system 100 and allow the registration of SIP devices in the system 100.

In operation, as will be explained in greater detail below, a user can set one or more appointments or other events using his calendar application 112 and associate one or more out of office messages therewith. When the date and/or time of the appointment or other event arrives, and a match to one or more user-configured labels or fields is found, the Out of Office Assistant 106 is automatically activated and an out of office message is sent by the messaging application 110 in response to incoming messages. When the appointment date or time ends, the Out of Office Assistant 106 is automatically deactivated.

In certain embodiments of the present invention, one or more of the components of the system 100 may be connected to or in communication with each other via a communication network. For example, turning now to FIG. 2, a system 120 including the components of the system 100 is illustrated, wherein some or all of the components are in communication via a network 122. The network 122 may be or include the Internet, World Wide Web, a local area network, or some other public or private computer, cable, telephone, client/server, peer-to-peer, or communication network or intranet. In some embodiments, the communication network can also include other public and/or private wide area networks, local area networks, wireless networks, data communications networks, or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology. In some embodiments, some or all of the network 122 may be implemented using a TCP/IP network and may implement voice or multimedia over IP using, for example, the Session Initiation Protocol (SIP).

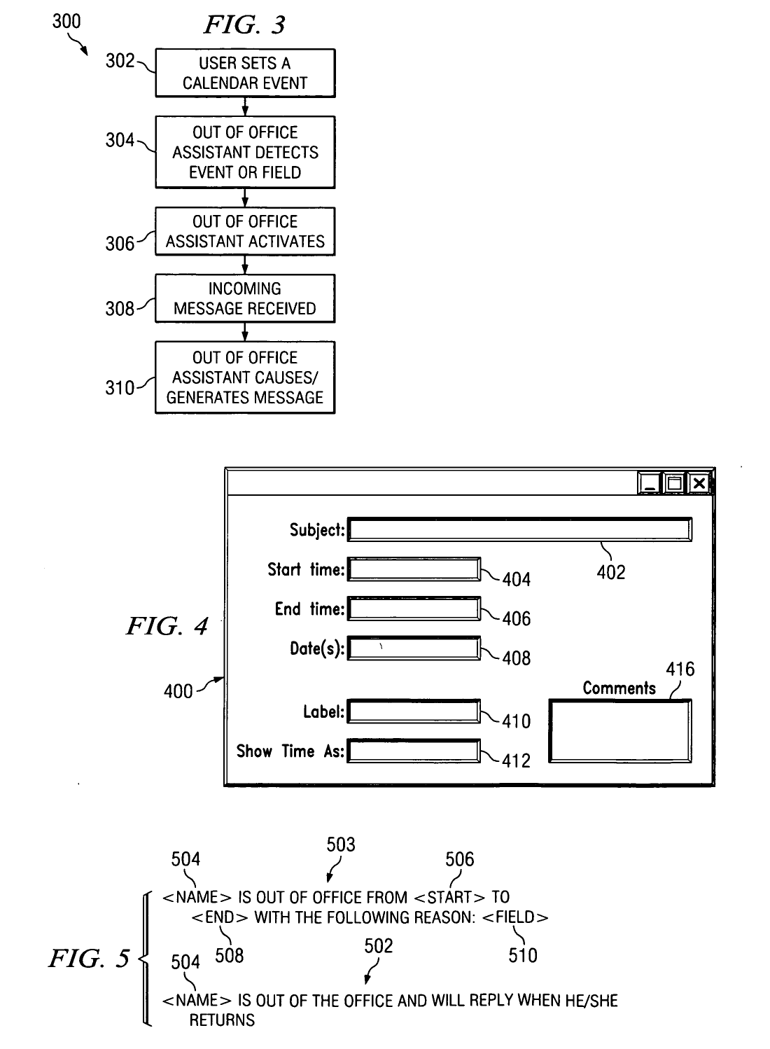

Turning now to FIG. 3, a flowchart 300 illustrating operation of embodiment of the present invention is shown. The particular arrangement of elements in the flowchart 300 is not meant to imply a fixed order to the elements; embodiments can be practiced in any order that is practicable. In particular, the flowchart 300 is a high level diagram generally illustrating operation of an Out of Office Assistant in accordance with embodiments of the present invention.

In a step 302, a user can set a calendar event using his calendar application 112 and, in certain embodiments, in conjunction with the calendar system 104. In a step 304, the Out of Office Assistant 106 can detect or be notified of the occurrence of the calendar event or of user-configured descriptive fields associated with the event. In response to this detection, in a step 306, the Out of Office Assistant 106 will automatically activate. In a step 308, an incoming message may be received by the messaging system 102 and may be forwarded to the messaging application 110. In a step 310, the Out of Office Assistant 106 detects the incoming message and generates, or causes to be generated, an outgoing message, which the messaging system will send to the sender of the incoming message. When the time of the appointment ends, the Out of Office Assistant 106 is automatically deactivated.

Turning now to FIG. 4, a diagram illustrating an exemplary application window 400 is shown. The application window 400 may be generated, for example, by the calendar application 112 and/or the Out of Office Assistant 106. The application window 400 allows a user to set an appointment and, in accordance with embodiments of the present invention, configure his out of office assistant.

In the example illustrated, the application window 400 includes a Subject field 402, for entering a calendar event subject; and a Start Time entry field 404, an End Time entry field 406, and a Date field 408 for setting start and end times, and date or a date range. In addition, a Label field 410 allows a user to select one or more labels; a Show Time As field 412 allows a user to set a date descriptor; and a Comments field 416 allows a user to enter comments about the meeting or appointment. Exemplary Show Time As field entries include BUSY, FREE, OUT OF OFFICE, and TENTATIVE. Exemplary Label fields include IMPORTANT, VACATION, PHONE CALL, etc.

In operation, as will be explained in greater detail below, the Out of Office Assistant 106 may be configured to automatically activate to provide an outgoing message upon the occurrence of, and during, calendar events. The particular outgoing message may be customized according to the Subject, Label, Show Time As, or Comments fields. When the date of an appointment occurs, the system will operate to check if the Out of Office Assistant needs to be activated.

According to certain embodiments, when the time of the appointment occurs, the Out of Office Assistant 106 is activated to generate the configured out of office message when an incoming message is received. The message itself may be a default or configured for the specific calendar content including, for example, the label or other fields. When the appointment ends, the Out of Office Assistant 106 is automatically deactivated.

In other embodiments, when the time of the appointment occurs, the Label, Show Time As, or other field will be checked. If there is a match, then the Out of Office Assistant 106 is activated. If a message is received, the Out of Office Assistant 106 will generate either a custom, user-configured reply message or a default message. In certain embodiments, the custom reply can be based on the calendar content.

For example, shown in FIG. 5 are exemplary default and preconfigured outgoing messages. At 502, an exemplary default message is shown. In the example illustrated, the message 502 includes a name field 504, and the message “<NAME> is out of the office and will reply when he/she returns.” In operation, as discussed above, the Out of Office Assistant 106 automatically activates when the time of the appointment occurs or when there is a LABEL or other field match. In certain embodiments, the message 502 is automatically generated when a message is received.

Also shown is a message 503 that can be generated automatically based on the appointment or event content. Shown is a name field 504, a start field 506, end field 508, and reason field 510. The name field 504 may be the user name, for example. The start and end fields 506, 508 can be the start and end times or start and end dates. For example, if the period of absence is less than one day, the system will insert the hours of absence; if it is more than one day, the system will insert the dates. Finally, the reason field 510 may be the reason label or show time as field. (In principle, the subject and comments fields could also be used, although these may generally be too long). In certain embodiments, the message 503 is automatically generated when a message is received.

As will be explained in greater detail below, the user can configure to Out of Office assistant 106 to automatically activate when a calendar event occurs (or based on calendar event content), generate the default message or the custom message when a message is received, and deactivate when the event is over.

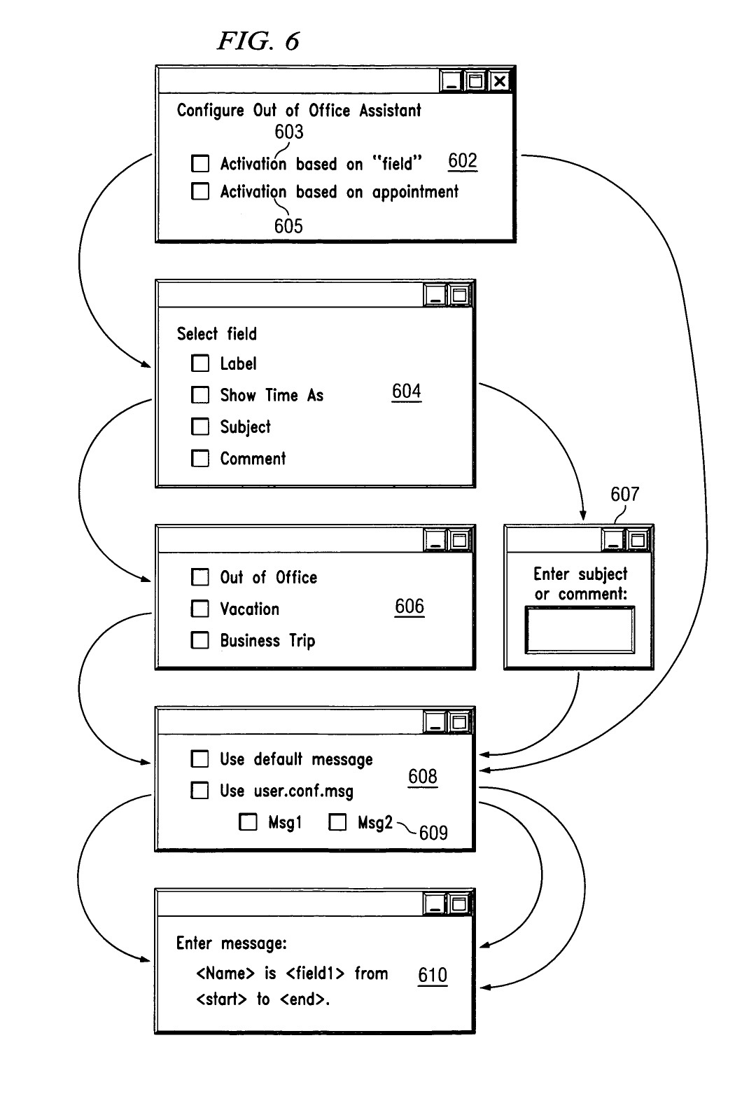

Turning now to FIG. 6, a diagram schematically illustrating one method for configuring an Out of Office Assistant 106 in accordance with embodiments of the present invention is shown. It is noted that, while a variety of graphical user interface windows are shown, they are exemplary only.

Shown at 602 is an exemplary Configure Out of Office Assistant window. The Configure Out of Office Assistant window 602 allows the user to select Activation based on a field at 603 or based on an appointment at 605.

If the user selects activation based on Field, i.e., calendar event content, then he can select a field using window 604. In the example illustrated, the select field window 604 allows the user to select the field that is to be used for the basis of activation. In the embodiment illustrated, this can include Label, Show Time As, Subject, or Comment fields.

The user can select, for example, Label, in which case, he can use window 606 to select the specific label. For example, as illustrated, this can include Out of Office, Vacation, or Business trip. Once the user selects the label, he can select the outgoing message, using window 608. In the example illustrated, the user can select “Use Default Message” or “Use user-configured message.” In certain embodiments, if the user selects User-Configured message, he may be given the option at 609 of selecting which one (e.g., Msg. 1 or Msg. 2), if more than one has already been stored. Alternatively, using window 610, the user may be given the option of entering a new message or messages.

If, using window 604, the user had selected Subject or Comment, then he would have been given the option in window 607 to enter the subject or comment text that was to be used. The user could then use windows 608, 610 to complete the configuration.

If, using window 602, the user had selected the activation based on appointment 606, he could then enter the default message at 608 or enter a message at 610.

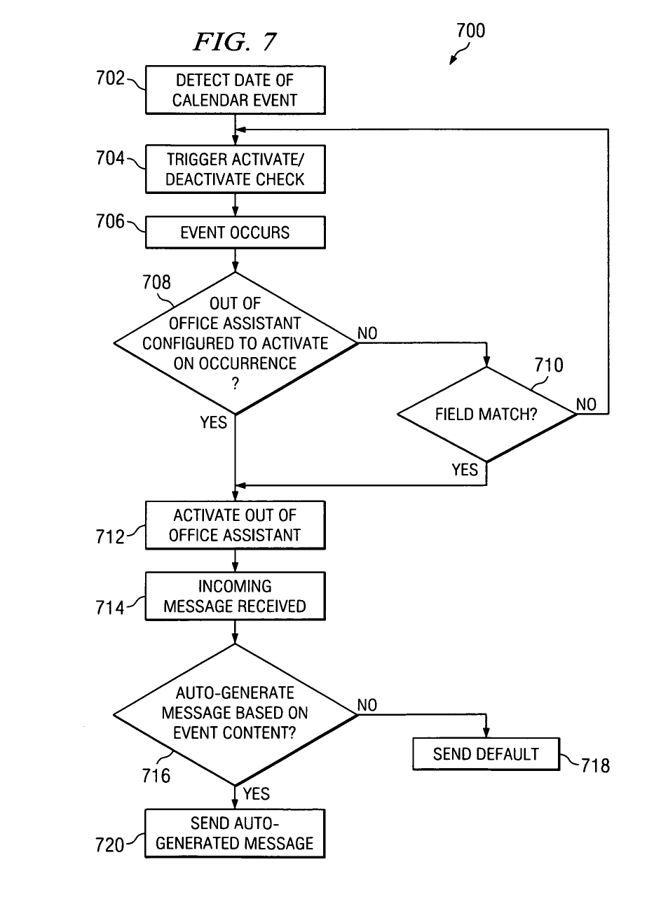

Turning now to FIG. 7, a flowchart 700 illustrating operation of embodiment of the present invention is shown. The particular arrangement of elements in the flowchart 700 is not meant to imply a fixed order to the elements; embodiments can be practiced in any order that is practicable.

Initially, in a step 702, the date of a calendar event is detected. For example, the calendar application 112 or system 104 can be configured to send a suitable notification to the Out of Office Assistant 106. In a step 704, this can trigger an activation/deactivation alert by the Out of Office Assistant 106. In a step 706, the calendar event occurs.

In a step 708, the Out of Office Assistant 106 checks if it is configured to activate upon the occurrence of the event. If so, then in a step 712, the Out of Office Assistant 106 will automatically activate. Alternatively, the Out of Office Assistant will check for a field match in a step 710. If there is such a match, the Out of Office Assistant 106 will activate at step 712. Otherwise, it will remain deactivated and wait for another check.

An incoming message can be received at step 714. At a step 716, the Out of Office Assistant 106 determines if it is configured to auto-generate a message based on the event content. If so, it will send the appropriate message at a step 720. Otherwise, in a step 718, it will send the default message.

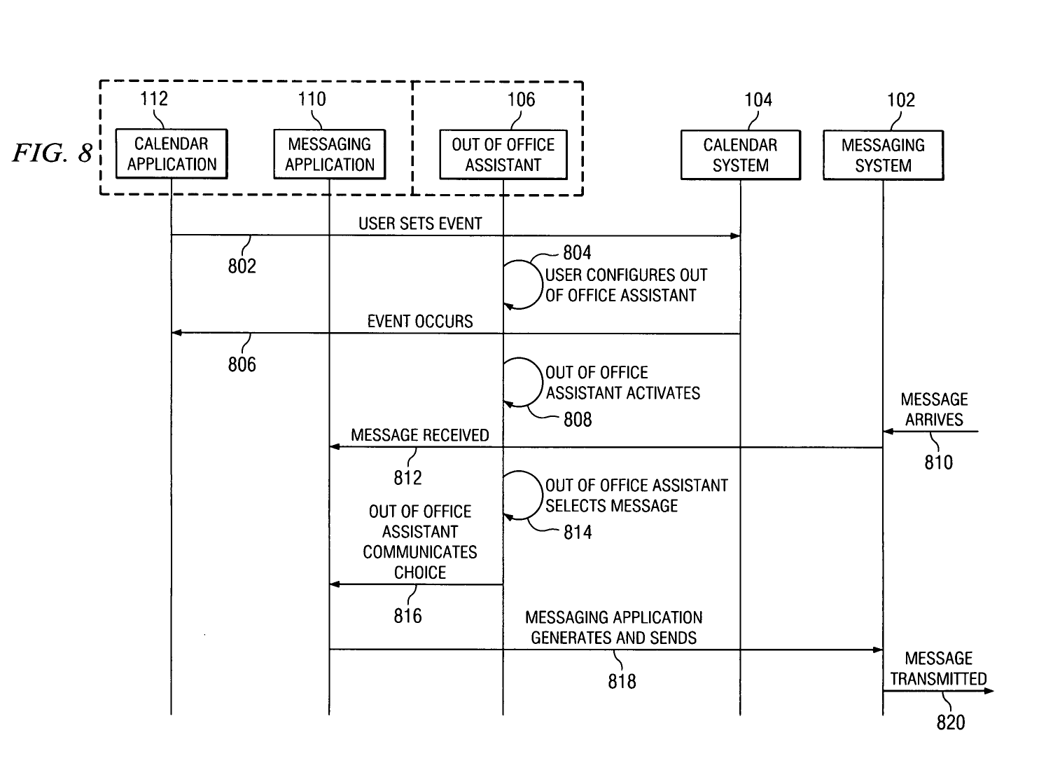

Now referring to FIG. 8, a diagram illustrating exemplary signaling flow for operation of an embodiment of the present invention is shown. In particular, shown are calendar application 112, messaging application 110, out of office assistant 106, calendar system 104, and messaging system 102.

In the embodiment illustrated, the calendar application 112, messaging application 110, and out of office assistant 106 may be application programs running on a user device or endpoint (not shown). The calendar system 104 and messaging system 102 may be implemented as one or more servers capable of communicating with the client endpoint. In some embodiments, the messaging is in the form of e-mail messaging or web-base e-mail.

At 802, a user can set his event using his calendar application 112; the information can be received by calendar system 104. At 804, the user can configure his Out of Office Assistant 106, in a manner similar to that discussed above. At 806, the calendar system 104 can inform the calendar application 112 and the Out of Office Assistant 106 of the occurrence of the scheduled calendar event.

At 810, an incoming message can arrive at the messaging system 102. The message can be downloaded to the messaging application 110, at 812. The arrival of the message can be detected by or communicated to the Out of Office Assistant 106, which can then select the appropriate outgoing message, at 814. The selection can be communicated to the messaging application 110 at 816. The messaging application 110 can generate the message and send it, at 818. The message is then received at the messaging system 102 and can be transmitted to the sender, at 820.

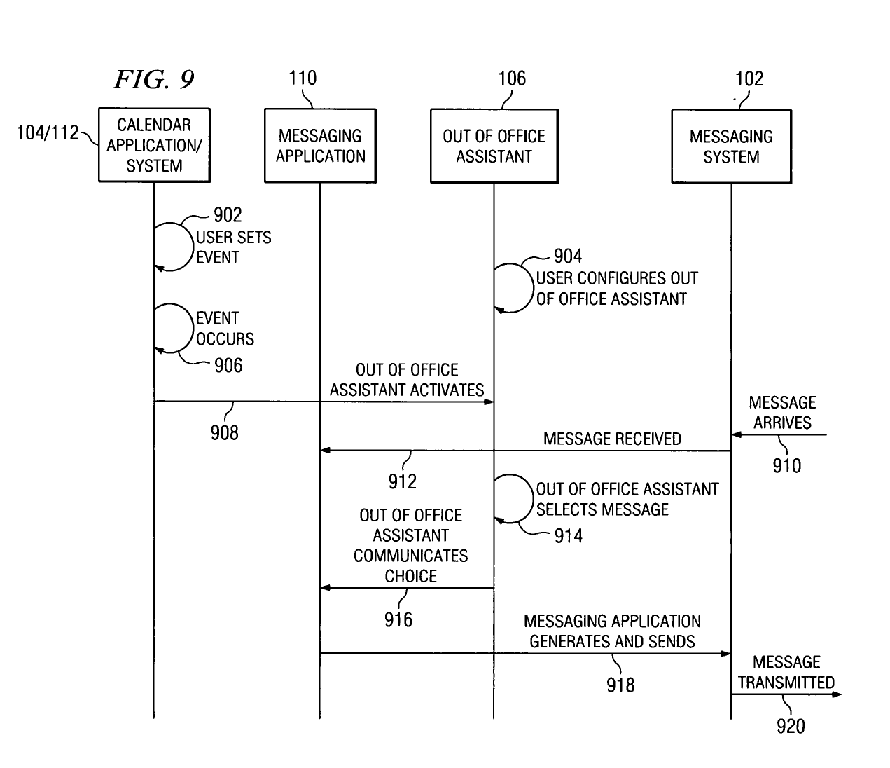

Now referring to FIG. 9, a diagram illustrating exemplary signaling flow for operation of another embodiment of the present invention is shown. In particular, shown are calendar system/application 104/112, messaging application 110, out of office assistant 106, and messaging system 102.

In the embodiment illustrated, the calendar system and application run on the client endpoint. In some embodiments, the messaging is in the form of e-mail messaging or web-base e-mail.

At 902, a user can set his event using his calendar system/application 104/112. At 904, the user can configure his Out of Office Assistant 106, in a manner similar to that discussed above. At 906, the calendar system/application 104/112 can detect the occurrence of a scheduled event and can notify the Out of Office Assistant 106 of the occurrence of the scheduled calendar event. In response, at 908, the Out of Office Assistant activates.

At 910, an incoming message can arrive at the messaging system 102. The message can be downloaded to the messaging application 110, at 912. The arrival of the message can be detected by or communicated to the Out of Office Assistant 106, which can then select the appropriate outgoing message, at 914. The selection can be communicated to the messaging application 110 at 916. The messaging application 110 can generate the message and send it, at 918. The message is then received at the messaging system 102 and can be transmitted to the sender, at 920.

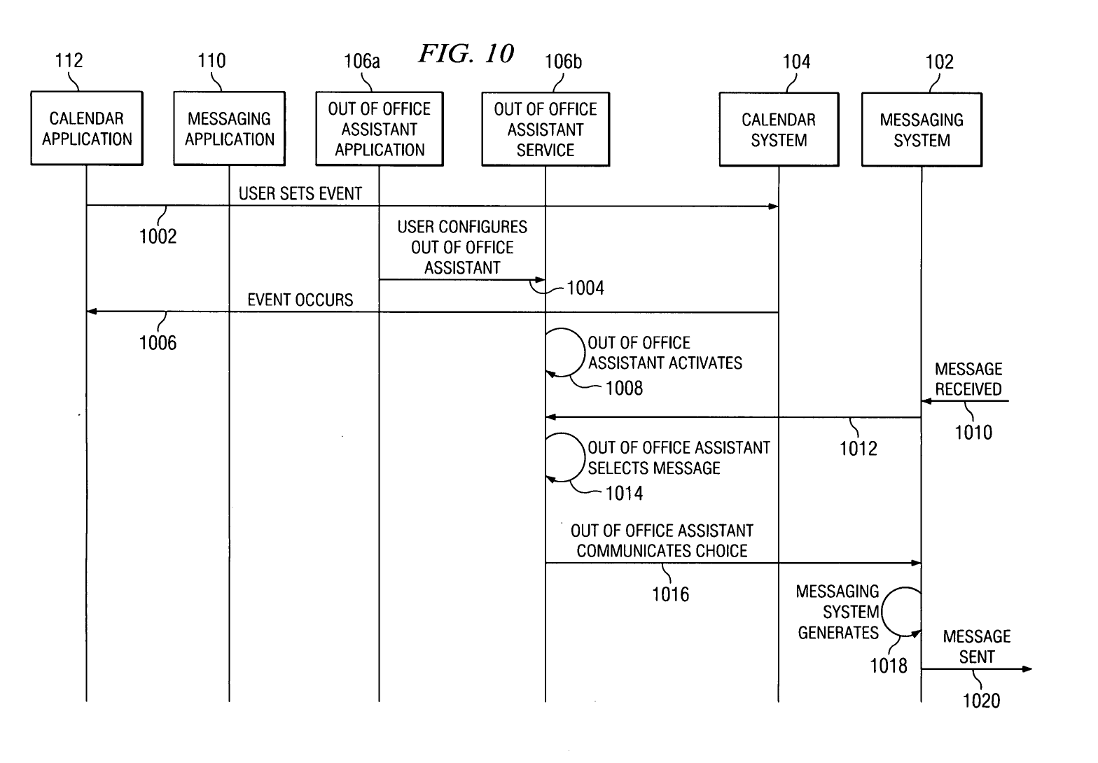

Now referring to FIG. 10, a diagram illustrating exemplary signaling flow for operation of another embodiment of the present invention is shown. In particular, shown are calendar application 112, messaging application 110, out of office assistant application 106a, calendar system 104, messaging system 102, and Out of Office Assistant service 106b.

In the embodiment illustrated, the calendar application 112, messaging application 110, and out of office assistant application 106a may be application programs running on a user device or endpoint (not shown). The calendar system 104, messaging system 102, and out of office assistant service 106b may be implemented as one or more servers capable of communicating with the client endpoint. In some embodiments, the messaging is in the form of e-mail messaging or web-base e-mail.

At 1002, a user can set his event using his calendar application 112; the information can be received by calendar system 104. At 1004, the user can use his Out of Office Assistant 106a to configure his Out of Office Assistant service 106b, in a manner similar to that discussed above. At 1006, the calendar system 104 can inform the calendar application 112 and the Out of Office Assistant service 106b of the occurrence of the scheduled calendar event.

At 1010, an incoming message can arrive at the messaging system 102. The arrival of the message can be detected by or communicated to the Out of Office Assistant service 106b, which can then select the appropriate outgoing message, at 1014. The selection can be communicated to the messaging system at 1016. The messaging system 102 can generate the message and send it, at 1018. The message is then received at the messaging system 102 and can be transmitted to the sender, at 1020. If the user logs in, he can then receive notification of incoming and sent messages.

Now referring to FIG. 11, a representative block diagram of a computer or processing device 1100 suitable for use as a user device or server according to embodiments of the present invention is shown. In some embodiments, the computer 1100 may include or operate a calendar application or client; a messaging application or client; and an Out of Office Assistant or client. In server embodiments, the computer 1100 can implement a calendar system, a messaging system, or an Out of Office service. The computer 1100 may be embodied as a single device or computer, a networked set or group of devices or computers, a workstation, mainframe or host computer, etc. In some embodiments, the computer 1100 may implement one more elements of the methods disclosed herein.

The computer 1100 may include a processor, microchip, central processing unit, or computer 1102 that is in communication with or otherwise uses or includes one or more communication ports or network interfaces 1104 for communicating with user devices and/or other devices. The communication ports 1104 may include such things as local area network adapters, wireless communication devices, Bluetooth technology, cellular network interfaces, etc. The computer 1100 also may include an internal clock element 1106 to maintain an accurate time and date for the computer 1100, create time stamps for communications received or sent by the computer 1100, etc.

If desired, the computer 1100 may include one or more output devices 1108 such as a printer, infrared or other transmitter, antenna, audio speaker, display screen or monitor, text to speech converter, etc., as well as one or more input devices 1110 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the computer 1100 may include a memory or data storage device 1120 to store information, software, databases, documents, communications, device drivers, etc. The memory or data storage device 1120 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. Thus, the storage device 1120 may include various combinations of moveable and fixed storage. The computer 1100 also may include memory 1114, such as ROM 1116 and RAM 1118.

The processor 1102 and the data storage device 1120 in the computer 1100 each may be, for example: (i) located entirely within a single computer or other computing device; or (ii) connected to each other by a remote communication medium, such as a serial port cable, telephone line or radio frequency transceiver. In one embodiment, the computer 1100 may be implemented as one or more computers that are connected to a remote server computer, as will be explained in greater detail below.

A conventional personal computer or workstation with sufficient memory and processing capability may be used as the computer 1100. The computer 1100 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 1102. Other suitable processors may be available from Motorola, Inc., AMD, or Sun Microsystems, Inc. The processor 1102 also may be embodied as one or more microprocessors, computers, computer systems, etc.

Software may be resident and operating or operational on the computer 1100. The software may be stored on the data storage device 1120 and may include a control program 1122. In the client devices, the control program 1122 may include the messaging application, the calendar application, and the out of office assistant application. In the server, the control program 1122 can include the messaging system, the calendar system, and the out of office assistant service.

The control program 1122 may control the processor 1102. The processor 1102 may perform instructions of the control program 1122, and thereby operate in accordance with the methods described in detail herein. The control program 1122 may be stored in a compressed, uncompiled and/or encrypted format. The control program 1122 furthermore may include program elements that may be necessary, such as an operating system, a database management system and device drivers for allowing the processor 1102 to interface with peripheral devices, databases, etc. Appropriate program elements are known to those skilled in the art, and need not be described in detail herein.

The computer 1100 also may include or store user information regarding identities, user devices, contexts, presence information, communications, etc. These may include, for example, default messages, etc. Information regarding other application program data may be stored in application databases (not shown)

According to some embodiments, the instructions of the control program may be read into a main memory from another computer-readable medium, such as from the ROM 1116 to the RAM 1118. Execution of sequences of the instructions in the control program causes the processor 1102 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 1102, communication ports 1104, clock 1106, output device 1108, input device 1110, data storage device 1120, ROM 1116 and RAM 1118 may communicate or be connected directly or indirectly in a variety of ways. For example, the processor 1102, communication ports 1104, clock 1106, output device 1108, input device 1110, data storage device 1120, ROM 1116 and RAM 1118 may be connected via a bus 1134.

While specific implementations and hardware/software configurations for the computer 1100 have been illustrated, it should be noted that other implementations and hardware configurations are possible and that no specific implementation or hardware/software configuration is needed. Thus, not all of the components illustrated in FIG. 11 may be needed for the computer 1100 implementing the methods disclosed herein.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, in some embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. The drawings are not necessarily to scale and illustrate the device in schematic block format. It is intended that the scope of the invention be defined by the claims appended hereto, and their equivalents

What is claimed is:

1. A method, comprising:
creating a calendar appointment in a calendar program; and
automatically activating an out of office assistant at a time of said appointment.

2. A method in accordance with claim 1, wherein said automatically activating includes generating a message responsive to an incoming message during a time of said appointment.

3. A method in accordance with claim 1, further comprising applying one or more descriptive fields to said appointment, wherein said automatically activating includes generating a message responsive to said one or more descriptive fields.

4. A method in accordance with claim 2, wherein said message comprises a default message.

5. A method in accordance with claim 4, including generating a different message based on different fields.

6. A system, comprising:
a calendar system; and
an out of office assistant configured to activate responsive to one or more entries maintained in the calendar system.

7. A system in accordance with claim 6, wherein said out of office assistant is configured to activate based on fields applied to calendar appointments maintained by the calendar system.

8. A system in accordance with claim 6, wherein said out of office assistant is configured to activate based on calendar appointments maintained by the calendar system.

9. A system in accordance with claim 6, wherein said out of office assistant is configured to cause to be generated a reply message based on content of a calendar maintained by the calendar system.

10. A system in accordance with claim 9, wherein said reply message is user-configurable.

11. A system in accordance with claim 9, wherein said reply message is a default message.

12. Machine-readable media storing one or more programs and/or data for performing a method comprising:
maintaining a calendar system; and
activating an out of office assistant responsive to one or more entries maintained in the calendar system.

13. Machine-readable media storing one or more programs and/or data for performing a method in accordance with claim 12, wherein said out of office assistant is configured to activate based on fields applied to calendar appointments maintained by the calendar system.

14. Machine-readable media storing one or more programs and/or data for performing a method in accordance with claim 12, wherein said out of office assistant is configured to activate based on calendar appointments maintained by the calendar system.

15. Machine-readable media storing one or more programs and/or data for performing a method in accordance with claim 12, further comprising generating a reply message based on content of a calendar maintained by the calendar system.

16. Machine-readable media storing one or more programs and/or data for performing a method in accordance with claim 15, wherein said reply message is user-configurable.

17. Machine-readable media storing one or more programs and/or data for performing a method in accordance with claim 15, wherein said reply message is a default message.

18. A processing device, comprising:
a processor; and
a memory operably coupled to the processor storing code executable by the processor for creating a calendar appointment in a calendar program; and automatically activating an out of office assistant at a time of said appointment.

19. A processing device in accordance with claim 18, wherein said automatically activating includes generating a message responsive to an incoming message during a time of said appointment.

20. A processing device in accordance with claim 18, said code executable by the processor for applying one or more descriptive fields to said appointment, wherein said automatically activating includes generating a message responsive to said one or more descriptive fields.
